(19) United States
(12) Patent Application Publication
(10) Pub. No.: US 2006/0126709 A1
(43) Pub. Date: Jun. 15, 2006

(54) VDSL transmission between two groups of modems

(75) Inventor: Olivier Isson, Voreppe (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics S.A., Montrouge (FR)

(21) Appl. No.: 11/302,701

(22) Filed: Dec. 14, 2005

(30) Foreign Application Priority Data
Dec. 14, 2004 (FR) 04/52959

(51) Int. Cl. H04B 1/38

(52) U.S. Cl. 375/222

(57) ABSTRACT

The transmission of data between two VDSL modems respectively belonging to two groups of a same number of modems connected two by two by lines of a same cable, including, for each carrier, the steps of determining a possible set of values according to the number of bits assigned to the carrier, and configuring, based on this set, a circuit for searching the value of each received sample, by implementation of a maximum likelihood algorithm.

### BACKGROUND OF THE INVENTION

1. Field of the Invention

The present invention generally relates to transmissions between VDSL (Very high rate Digital Subscriber Line) or Zipper-VDSL modems which use the telephone lines as a high-rate digital transmission support (on the order of 50 megabits per second). The present invention more specifically relates to transmissions between two groups of modems physically located at both ends of a multiline cable.

An example of application of the present invention relates to cable connections between equipment (telephone exchanges, switches, etc.) used as transmission relays for VDSL communications. Electronic cards comprising several VDSL modems are then generally connected from one exchange to another by wire communication links contained in the same cable.

2. Discussion of the Related Art

FIG. 1 very schematically shows in the form of blocks an example of architecture of a VDSL transmission system.

Several subscribers 1 (SUBSC) individually connected to a telephone line 2 communicate via telephone exchanges 3 (CENT) used as transmission relays between communications. A communication between two subscribers generally transits through several exchange systems. To simplify the description of the present invention, the term “exchange” will be used to designate a switch, sub-switch, or exchange, and more generally any collective equipment used as an intermediary for several communications, provided that modems or another collective element are connected thereto by sharing at least a portion of a multiline cable. In particular, it may be a connection between an exchange and a data server receiving several communication lines or a connection of several subscriber modems to the same exchange.

FIG. 2 very schematically illustrates, in the form of blocks, an example of a VDSL transmit-receive structure between a transmitter modem and a receiver modem interconnected by a telephone line type wire link 5.

A bit flow Tx to be transmitted is, in VDSL technology, distributed over several carriers or channels in QAM modulation. The number of carriers and the number of transmitted bits per carrier depends on the quality of connection 5 and are established in a phase of initialization of the transmission between the two modems.

The distribution of the bits to be transmitted over the different carriers is performed digitally by a circuit 6 (MAPPER) which provides an inverse fast Fourier transform block 7 (IFFT) with the bits to be modulated over the different carriers C₁ to Cₙ. The data are modulated in QAM over these carriers and the n outputs of block 7 are serialized (block 8, P/S) before a digital-to-analog transmission (block 9, D/A) to be transmitted on line 5.

On the receiver side, after an analog-to-digital conversion (block 10, A/D), the different carriers or different channels C₁ to Cₙ are individualized by a series-to-parallel converter (block 11, S/P) before being sent onto a block 12 (FFT) performing a direct Fourier transform to provide the received data to interpretation circuits not shown.

The representation of FIG. 2 is very simplified. In particular, other transmit-receive elements (especially, analog transceiver heads) as well as the circuits for managing the VDSL protocol are present in the transmitter and receiver modems but have not been shown to simplify the description. For more details, reference may, for example, be made to standard ANSI Draft Technical Document, Revision 14A “Very-high-speed Digital Subscriber Lines System Requirements” T1E1.4 May 1998.

FIG. 3A illustrates, in a diagram showing number nb of transmitted bits versus frequency f, an example of the distribution of the number of transmitted bits on carriers Cᵢ (i ranging between 1 and n) in a VDSL transmission. In the illustrated example, it is assumed that the quality of transmission line 5 allows transmission of two bits only on a carrier Cᵢ of frequency fᵢ. In this case, the two bits of this carrier are coded in 4-QAM for their transmission, as illustrated in FIG. 3B showing the real and imaginary parts R and I of the obtained constellation. For a second carrier C_{i′} of frequency f_{i′} it is assumed that the state of line 5 allows transmission of 6 bits. A 64-QAM constellation is then used for this frequency f_{i′}, as illustrated by the constellation of FIG. 3C. More generally, the number of bits conditions the power of the QAM modulation. For p bits to be transmitted, a 2^{p}-QAM modulation is used.

In VDSL technology, communications between two end subscribers (1, FIG. 1) are divided into several transmissions between different exchanges separating the two subscribers. At each exchange, the data are demodulated and modulated back to be transmitted to the following relay. The used carriers and the bit distribution on these carriers are likely to be different in the successive transmissions according to the connection separating the transmitter exchange from the next receiver exchange.

FIG. 4 very schematically illustrates such a feature of VDSL networks and illustrates, in the form of blocks, an example of a collective equipment of switch type used to relay and redistribute communications that it receives over a cable 20 to other cables 21 and 22 according to the addressees. For simplification, a single transmission direction is considered in FIG. 4 (from cable 20 to cables 21 and 22). However, in VDSL technology, the communications are bi-directional, each modem being comprised of a transmit part and of a receive part. The function of the collective equipment in the example of FIG. 4 is that of a digital switch 23 comprising m modems RMODEM connected to cable 20. Another group of modems 25 (TMODEM) is connected to cable 21 (for simplification, a single modem 25 has been shown). Another group of modems 26 (TMODEM) is connected to cable 22.

Each receiver modem 24 or transmitter modem 25 or 26 has the structure of a VDSL modem such as described in simplified fashion in relation with FIG. 2. The present invention more specifically relates to the reception of data by the group of modems 24 having their physical transmission supports (lines 5) gathered at least for a portion of their length within the same cable 20 connecting lines 5 to a group of transmitter modems.

FIG. 5 very schematically shows a first group 30 of modems 27 (TMODEM1 to TMODEMm) sharing a same cable 20 gathering lines 5 connecting the different modems. Each modem 27 communicates individually with a modem 24 (RMODEM1 to RMODEMm) of a second group 31 connected to the other ends of lines 5.

When several telephone lines or equivalent physical transmission supports are shared by the same cable, this generates crosstalk problems. The present invention more specifically relates to far-end crosstalk problems (FEXT) whereby the signal received by a modem corresponds to a linear combination of the data transmitted over the same channel by all the modems of the other end.

Noting X the data transmitted by a first modem Mⱼ on a line 5ⱼ and Y the data transmitted by a second modem M_{j′} of the same end on a second line 5_{j′}, of the same cable for a given channel (carrier), the data received at the other ends of lines 5ⱼ and 5_{j′} may be expressed by the following relations:

For line 5ⱼ: aX+bY+Nj; and

For line 5ⱼ: cX+dY+Nj′,

where a, b, c, and d represent the respective amplitudes with which the data are received by the modems, and where Nj and Nj′ represent additional background noises generally lower than far-end crosstalk noises (bY for line 5ⱼ and cX for line 5_{j′}).

To simplify the above expressions, the case of two modems has been considered. It should however be noted that such linear combinations are a function of the number of modems sharing the cable.

A disadvantage of far-end crosstalk noises is that they limit transmission rates on the lines.

In VDSL, a known technique to reduce far-end crosstalk noises consists of multiplying, in receive mode, the set of received data by a matrix. Noting M this matrix, Z=HU+N the received vector, with H designating the transfer matrix of the connection

$$\text{(} H = ( \begin{matrix}a & b \\ c & d\end{matrix} )$$

for above lines 5ⱼ and 5_{j′}), N representing the background noise, and U the data vector (U=(X, Y)), a vector W can be written as being equal to product MZ, and thus MHU+MN. Thus, in the case where matrix M is the inverse of matrix H, W=U+MN is obtained, which amounts to inverting the multiple-line channel. This technique is described, for example, in article “Vectored transmission for digital subscriber line systems” by G. Ginis and J-M. Cioffi, IEEE Journal on Selected Areas in Communications (June 2002, vol. 20, No. 5).

A disadvantage of this technique is that, for a great number of lines, calculations are very complex. Further, the application of this technique generates a noise on the order of MN that may be high. Further, the bit error rates remain significant.

### SUMMARY OF THE INVENTION

The present invention aims at solving all or part of the disadvantages of known systems.

The present invention particularly aims at decreasing the power of crosstalk noises in the reception of data by VDSL modems, to improve the transmission rate.

To achieve all or part of these objects as well as others, the present invention provides a method of data transmission between two VDSL modems respectively belonging to two groups of a same number of modems connected two by two by lines sharing at least a portion of a same cable, comprising, for each carrier, the steps of:

determining a possible set of values according to the number of bits assigned to the carrier; and

configuring, based on this set, a circuit for searching the value of each received sample, by implementation of a maximum likelihood algorithm.

According to an embodiment of the present invention, the set of possible values is dynamically adapted in case of a modification of the number of bits for the considered carrier.

According to an embodiment of the present invention, the maximum likelihood algorithm is implemented over a subset of possible values.

The present invention also provides a system of VDSL data transmission between two groups of modems connected two by two by connections sharing at least a portion of a same cable, comprising, on the receive side, a maximum likelihood circuit for the samples received on the different carriers, the set of possible values being a function of the carrier and of the number of bits assigned thereto.

According to an embodiment of the present invention, the set of possible values is dynamically adapted to the number of bits assigned to each carrier.

The present invention also provides a collective equipment of a VDSL transmission network.

The foregoing and other objects, features, and advantages of the present invention will be discussed in detail in the following non-limiting description of specific embodiments in connection with the accompanying drawings.

### BRIEF DESCRIPTION OF THE DRAWINGS

FIGS. 1 to 5, previously described, are intended to show the state of the art and the problem to solve;

FIG. 6 very schematically shows in the form of blocks an embodiment of a circuit for receiving transmissions by several modems sharing at least part of the length of the same multiline cable according to the present invention;

FIG. 7 functionally shows a processor for calculating the highest likelihood according to an embodiment of the present invention;

FIGS. 8A to 8D illustrate the operation of the data transmission method according to an embodiment of the present invention; and

FIG. 9 illustrates the operation of a preferred embodiment of the method of the present invention.

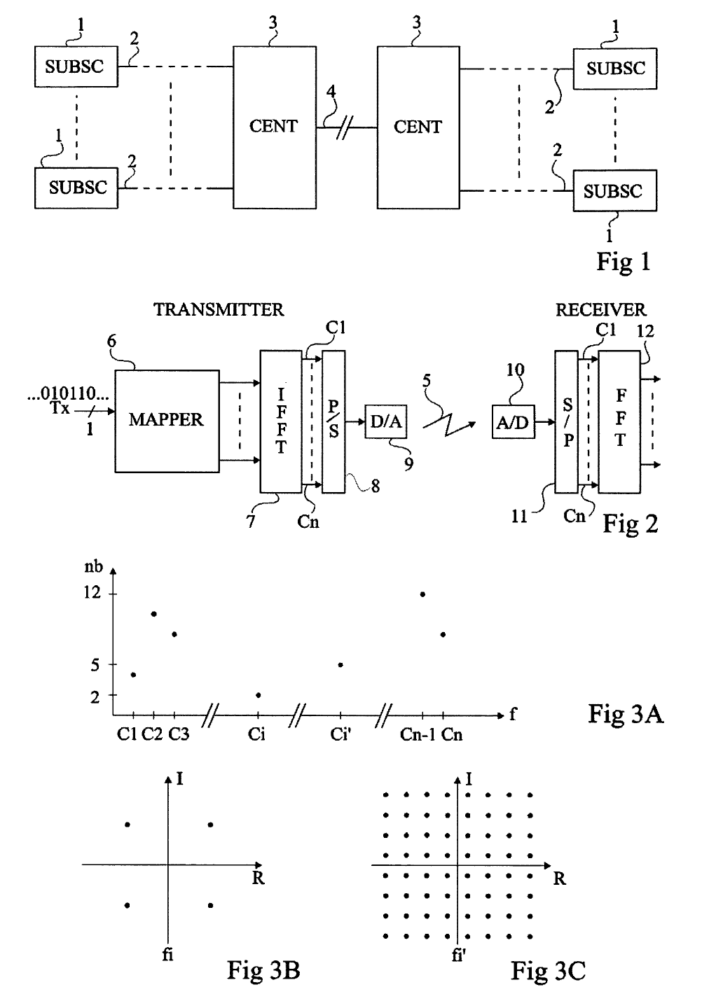

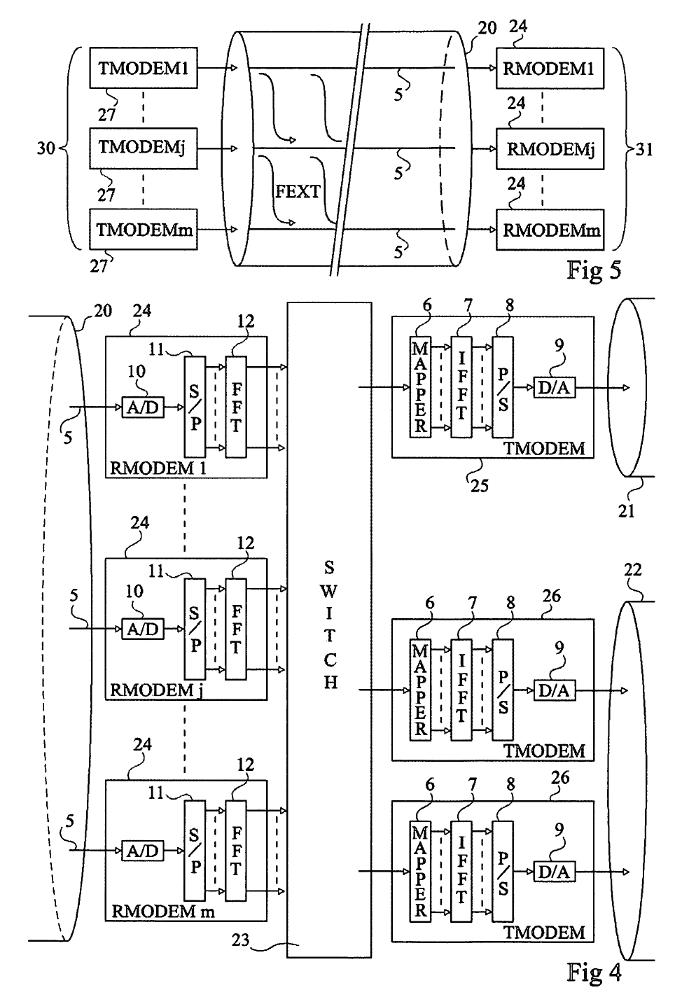

### DETAILED DESCRIPTION

The same elements have been designated with the same reference numerals in the different drawings. For clarity, only those elements and steps of the method which are useful to the understanding of the present invention have been shown and will be described. In particular, the details constitutive of the VDSL modems upstream of the direct Fourier transforms on the receive side have not been shown, the present invention being compatible with conventional structures. Similarly, the protocols for assigning a number of bits per carrier in a so-called “Zipper-VDSL” technology have not been described in detail since the present invention exploits conventional protocols.

A feature of an embodiment of the present invention is to implement, in a transmission between two groups of VDSL modems in which a modem of each group is connected to a modem of the other group by a physical connection contained at least partly in the same cable as connections connecting other modems, a so-called maximum likelihood technique on the receive side.

The search for the maximum likelihood in a constellation of received points comprises using, on the receive side, a set of definition of the data likely to have been transmitted by the transmitter and of searching, in this set, the most likely transmitted data.

The implementation of this technique is made possible since the transmitted data are digital values (bits), which enables establishing a set of discrete values likely to be received by the receiver modem.

According to an embodiment of the present invention, a set of possible data is established for each channel (each carrier).

The technique of data reception by search of the maximum likelihood is known per se and is described, for example, in “Digital Communications” by J. G. Proakis, published by McGraw-Hill in 1995 (3^{rd} edition).

The implementation of a maximum likelihood technique requires knowing the possible set of received data, which depends on the transmission characteristics of the line. Now, in a VDSL-type transmission between two collective elements or between a collective element and several user terminals and in the reverse direction, these characteristics are likely to change from one initialization to another of the transmission (or even dynamically). However, all modems share at least a portion of the cable, and the number of connectable modems is known as well as the maximum number of carriers.

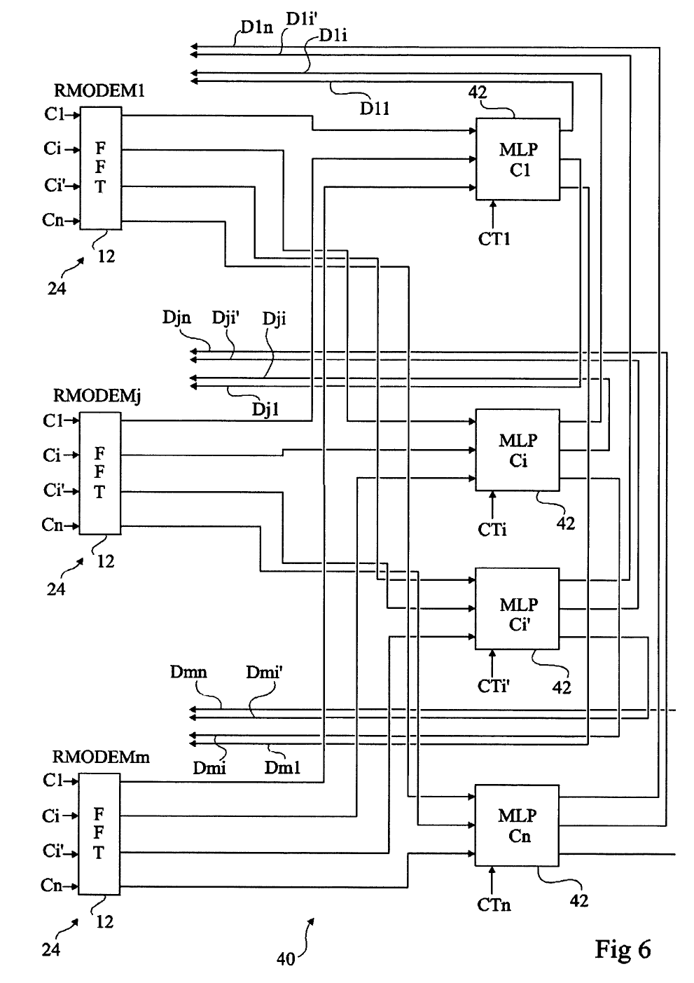

FIG. 6 very schematically shows in the form of blocks an architecture of a maximum likelihood calculation processor 40 in a collective equipment of communication network exchange type implementing a VDSL technology. For simplification, only the receive portion has been partially shown in FIG. 6, the other components being conventional.

As previously, a group of modems 24 sharing the same cable (20, FIG. 5) is in charge of demodulating data transmitted by a group of the same number of modems connected to the other end of the cable. In FIG. 6, modems 24 have been partially represented by their respective Fourier transform calculation blocks 12 (FFT). Each modem receives data on a number n of channels Cᵢ corresponding to the carriers in the VDSL transmission system. The data are transmitted in QAM modulation with a number of bits per carrier depending on an initialization phase testing the quality of the transmission line. If, as in the example, it is considered that each modem can decode data over n carriers, n represents the maximum number of carriers and the number of bits transmitted on certain carriers may be zero according to the state of the connection.

In practice, in the initialization (for example, turning-on of the modem), an exchange protocol establishes between the transmitter modem and the receiver modem, to test the possible rates on the different carriers. This test phase enables configuring the transmitter modem so that it transmits a number of bits on each carrier. Subsequently, during a communication, the flow rates of each carrier cannot be modified without going through an initialization phase, except for a bit swapping between two carriers. If the general communication flow rate cannot be maintained, the transmission is cut and the two modems start an initialization phase.

In an embodiment of the present invention, the protocols of bit assignment on the different carriers are used to adapt, at least on each initialization, the sets of possible values used for the maximum likelihood search.

According to the present invention, the respective outputs of processors 12 of calculation of the Fourier transforms are sent to one of a plurality (n) of circuits 42 for determining, for each carrier C₁ to Cₙ, the data transmitted by the application searching the maximum likelihood for the state of this data. Each circuit 42 is assigned to a carrier Cᵢ and receives the output of circuit 12 of each modem corresponding to this carrier. Each circuit 42 provides the state of the interpreted data Dji (j ranging between 1 and m) to modem RMODEMj, which then conventionally processes the data. Accordingly, the outputs of circuits 42 are sent to the usual received data processing circuits.

The fact that the number of possible carriers is known (set by the VDSL standard), and for the number of modems sharing a same cable is also known (generally, the collective elements are equipped with cards of a given number of modems) makes the architecture of FIG. 6 realizable.

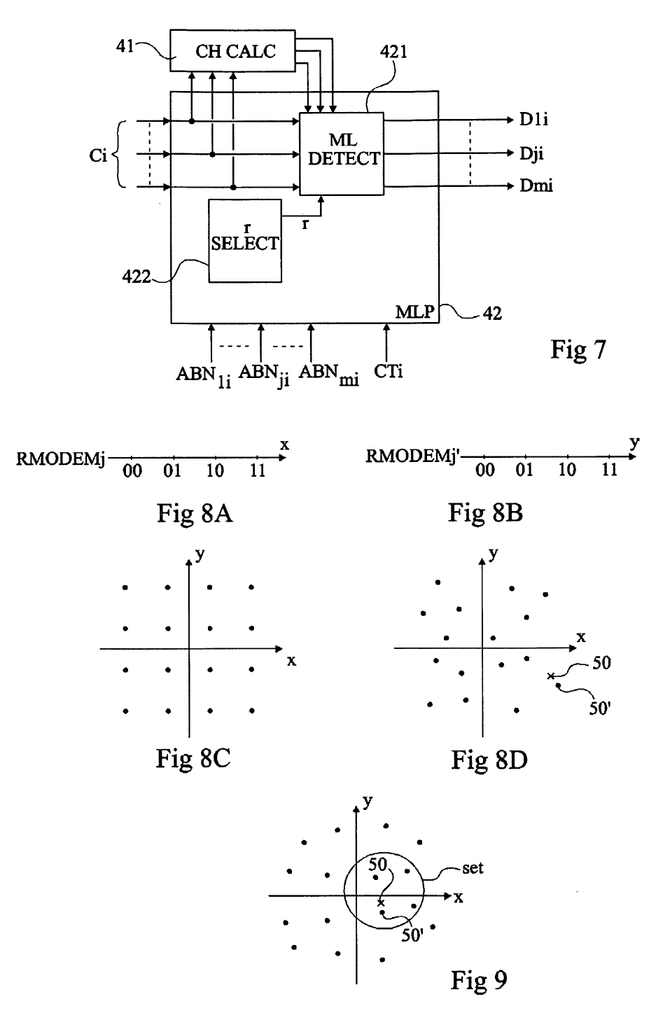

FIG. 7 schematically shows an embodiment of a maximum likelihood processor 42 (MLP) assigned to a carrier Cᵢ. The signals of carriers Cᵢ coming from the different modems of rank 1, . . . , j, . . . , m reach circuit 42 and are sent onto a detection circuit 421 in charge of determining, from a set of possible values, the values received by the different modems. The outputs of circuit 421 correspond to the outputs (carrying data D1i, . . . Dji, . . . , Dmi) sent to circuits 41 of the different modems.

Detector 421 is configured at least according to numbers ABN1i, . . . , ABNji, . . . ABNmi of bits assigned for each connection to the corresponding carrier. According to the present invention, number ABN (ranging between 0 and the maximum number n provided by the VDSL technology) originates from the circuits of the receiver modems which have, in the initialization of the communication, been used to establish the number of bits to be transmitted by the carrier. Other control signals CTᵢ are received by circuit 42, in particular, for configuration and synchronization needs.

The configuration of detector 421 is performed, for example, by an element 41 (CH CALC) of calculation of the transfer functions (H) of the connections, especially according to numbers ABN (thus also received by element 41). Element 41 can be common to all processors 42 since the transfer functions take into account both the carriers (i) and the connections (j).

The configuration of processors 42 is updated at least on each reinitialization of one of the connections. Preferably, it is then updated periodically and/or on each modification of the flow rate of two carriers by a bit swapping system.

In the embodiment of FIG. 7, circuit 42 also comprises an element 422 for selecting a likelihood radius r, the result of which is provided to detector 421. This radius corresponds to the acceptable amplitude variation to consider that a point is in an expected position. The determination of this threshold depends on a modeling, conventional per se, of the disturbances introduced by the line (among others, crosstalk). The present invention takes advantage of the fact that this modeling is however stable for a given line. Indeed, in wire connections of telephone line type, the transfer function of the transmission is stable between two groups of equipment. It is likely to be different between two successive cables carrying the same transmission between three successive groups of equipment, but remains relatively stable between each pair of collective elements. This is especially why the flow rates of the different carriers are different from one cable to another. In fact, if the transfer function varies, this causes, in VDSL technology, a reassignment of the flow rates on the different channels, and thus a reconfiguration of processors 42 by element(s) 41.

FIGS. 8A to 8D illustrate the operation of a maximum likelihood processor according to an embodiment of the present invention. To simplify the description, it is assumed that only two modems RMODEMj and RMODEMj′ share the cable, which enables considering a two-dimensional case. The transposition to a multidimensional practical case (dimension m) can be easily induced. Further, amplitude shift keying modulation transmissions are taken as an example to clarify the discussion by only considering the real part. The application to QAM modulation does not change the principle.

It is assumed that modems j and j′ each transmit four possible values on carrier i in 4-ASK modulation. The number of bits transmitted on carrier i is thus equal to 2. As a result (independently from the possible performed codings), each modem can transmit a set of values 00, 01, 10, or 11 by 4-ASK modulation (FIGS. 8A and 8B). These values have been symbolized on a single axis due to the absence of an imaginary part. In the case of a QAM modulation, the representations would be in two dimensions as in FIGS. 3B and 3C.

Due to the sharing of the transmission support and to the crosstalk effect, the possible sets of values may be represented in two dimensions (FIG. 8C) corresponding to the different possible combinations between the sets of the two modems RMODEMj and RMODEMj′. The representation of FIG. 8C does not correspond to the representation of a constellation in QAM, but to possible values for the linear combination of the transmissions of the different modems on the same carrier (the axes correspond to axes x and y representative of the two modems). On the receive side (FIG. 8D), the crosstalk modifies the values (amplitudes) received for each of the transmitted points. However, since it is a digital transmission and only binary states are likely to be received, the positions of the points define a discrete assembly.

The search for the maximum likelihood comprises the search for the point 50′ closest to a point 50 corresponding to the received value. In practice and according to the illustrated embodiment.

The implementation of a maximum likelihood in VDSL technology is made possible not only by the fact that it is a digital transmission, but also by the fact that the lines share, at least over a portion, the same cable. Most often, crosstalk noises are further lower than the amplitudes of the transmitted signals, which improves performance.

FIG. 9 illustrates a preferred embodiment of the present invention in which the maximum likelihood is limited to a subset of the possible points around the level received for the corresponding carrier as an application of the technique described in article “On Sphere Decoding Algorithm. I. Expected Complexity” by B. Hassibi and H. Vikalo, published in IEEE Transactions on Signal Processing. In simplified fashion, this amounts to defining a circle SET (in the example in two dimensions) around an effectively-received sample 50. This enables accelerating the process.

An advantage of the present invention is that it enables increasing the flow rate in VDSL transmission systems between two exchanges or more generally two collective elements of the transmission network which are connected to each other by a multiline cable connecting two groups having the same number of VDSL modems.

Of course, the present invention is likely to have various alterations, modifications, and improvements which will readily occur to those skilled in the art. In particular, the practical implementation of the present invention based on the functional indications given hereabove and by using conventional hardware and/or software tools is within the abilities of those skilled in the art.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method of data transmission between two VDSL modems respectively belonging to two groups of a same number of modems connected two by two by lines sharing at least a portion of a same cable, comprising, for each carrier, the steps of:
determining a possible set of values according to the number of bits assigned to the carrier; and
configuring, based on this set, a circuit for searching the value of each received sample, by implementation of a maximum likelihood algorithm.

2. The method of claim 1, wherein the set of possible values is dynamically adapted in case of a modification of the number of bits for the considered carrier.

3. The method of claim 1, wherein the maximum likelihood algorithm is implemented over a subset of possible values.

4. A system of VDSL data transmission between two groups of modems connected two by two by connections sharing at least a portion of a same cable, comprising, on the receive side, a maximum likelihood circuit for the samples received on the different carriers, the set of possible values being a function of the carrier and of the number of bits assigned thereto.

5. The system of claim 4, wherein the set of possible values is dynamically adapted to the number of bits assigned to each carrier.

6. A collective equipment of a VDSL transmission network, comprising, in its receive chain, means for implementing the method of claim 1.
